(19) United States
(12) Patent Application Publication
(10) Pub. No.: US 2009/0089524 A1
(43) Pub. Date: Apr. 2, 2009

(54) Storage Device Controlling Apparatus and Method

(76) Inventors: Shinobu Fujihara, Yamato-Shi (JP); Shinsuke Mitsuma, Tokyo-to (JP); Takeshi Inagaki, Sagamihara-Shi (JP); Kazuhiro Tsuruta, Sagamihara-city (JP); Terue Watanabe, Tokyo-to (JP)

Correspondence Address: IBM MICROELECTRONICS;INTELLECTUAL PROPERTY LAW, 1000 RIVER STREET, 972 E, ESSEX JUNCTION, VT, 05452, US

(21) Appl. No.: 12/237,542

(22) Filed: Sep. 25, 2008

(30) Foreign Application Priority Data
Sep. 28, 2007 (JP) 2007-253430

(51) Int. Cl. G06F 12/00; G06F 12/16; G06F 17/30

(52) U.S. Cl. 711/162; 711/154; 707/205; 711/E12.103; 711/E12.001; 707/E17.044

(57) ABSTRACT

A storage area, among multiple storage areas, which meets a predetermined requirement is determined to be a target for access. In a controller for controlling a multi-tiered storage subsystem, the following components operate under the control of a file write unit and a file read unit. First, a list acquiring unit obtains a list of tiers that can meet file access requirements. A requisite energy calculating unit calculates an additional energy amount necessary to satisfy file access requirements for each tier, an allowable energy calculating unit calculates an allowable additional energy amount, and a path retrieving unit determines a path to a target tier based on the energy amounts. An identifier acquiring unit obtains a file identifier, and an access point generating unit determines a file access point based on the path and the file identifier. A method for controlling a multi-tiered storage subsystem is also described.

### BACKGROUND

The present invention relates to a storage device controlling apparatus and method. In particular, the invention relates to an apparatus and method for controlling accesses to a storage device and data copying in the storage device.

In recent years, a multi-tiered storage system that combines multiple types of storage having different characteristics into a single logical storage has attracted attention (see, for example, the article “IBM Medical Archive Solution” (MAS) by Colin Blair, Julie Currie, Eric Goodall, Kevin McElyea, George Miller, and Ben Poston, November 2004, pp. 14-19, pp. 25-30, and pp. 45-51, the complete document of which is accessible online at URL http://www.redbooks.ibm.com/redpapers/pdfs/redp9130.pdf, and available in downloadable form at the website www.ibm.com, whose relevant pages are attached hereto as Appendix A).

In a multi-tiered storage system, a high-speed, small-capacity, and high-priced storage ranks high and a low-speed, large-capacity, and low-priced storage ranks low. In this case, each storage is called a “tier”. In this specification, types of storage are named “tier 1”, “tier 2”, and “tier 3” in descending order from the highest-order storage. For example, the system as described in the MAS paper uses an Internal Ultra320 SCSI disk as tier 1 and a serial ATA disk as tier 3.

Further, such a multi-tiered storage system passes file data through a tier configuration in response to any external access to a file. That is, the file is moved or copied from one tier to another on the basis of its attribute information (for example, last access date). For example, in the technique described in the MAS paper, a file stored in tier 1 will be moved to tier 2 two weeks later and to tier 3 three years later. However, if an external device sends a request to access a file, the file is moved or copied between tiers and thus moved back to tier 1. Finally, the file is accessed from a single file access point of tier 1. In this specification, the term “file access point” means information for accessing a target file on a tier. This point corresponds to, for example, a MAC address or IP address on a network level or to a pass on a file system level.

As described above, in the multi-tiered storage system as described in the MAS paper, it is uncertain which tier is selected upon file access. Accordingly, the technique described in the MAS paper has the following problem: it is not possible to select any tier of multiple tiers which meets a given requirement to be a target for access. This problem is involved in other storage systems that include multiple storage areas.

### BRIEF SUMMARY

In an embodiment of the present invention, it is possible to determine any storage area of multiple storage areas which meets a predetermined requirement to be a target for access.

An embodiment of the present invention provides a device for controlling access to a storage device having a plurality of storage areas, including: a first acquiring unit for acquiring a first information representing an energy amount necessary to access each of the plurality of storage areas with a required performance; a second acquiring unit for acquiring a second information representing an energy amount allowable for the access; and a selecting unit for selecting a target storage area from the plurality of storage areas in accordance with the first information acquired with the first acquiring unit and the second information acquired with the second acquiring unit.

In another embodiment of the present invention, data is copied from a plurality of storage areas. That is, an embodiment of the present invention also provides a device for controlling data copying in a storage device having a plurality of storage areas with different performance and energy consumption profiles, including: a selecting unit for selecting the plurality of storage areas, each storing one of a plurality of copies of the data; and a control unit for executing control such that a plurality of different portions of the plurality of copies of the data stored in the plurality of storage areas selected by the selecting unit are copied and combined in a predetermined storage area of the plurality of storage areas.

Another embodiment of the present invention provides a method for controlling access to a storage device having a plurality of storage areas, including: acquiring a first information representing an energy amount necessary to access each of the plurality of storage areas with a required performance; acquiring a second information representing an energy amount allowable for the access; selecting a target storage area from the plurality of storage areas in accordance with the first information and the second information; generating positional information for identifying at least one of a data write position in the target storage area selected by a selecting unit and a data read position in the target storage area; and performing at least one of an operation of writing a target data to the target storage area and an operation of reading the target data from the target storage area using the positional information generated.

Another embodiment of the present invention provides a program product for causing a computer to function as a device for controlling access to a storage device having a plurality of storage areas, the computer including: a first acquiring unit for acquiring a first information representing an energy amount necessary to access each of the plurality of storage areas with a required performance; a second acquiring unit for acquiring a second information representing an energy amount allowable for the access; and a selecting unit for selecting a target storage area from the plurality of storage areas in accordance with the first information acquired with the first acquiring unit and the second information acquired with the second acquiring unit.

### BRIEF DESCRIPTION OF THE SEVERAL VIEWS OF THE DRAWINGS

FIG. 1 is a conceptual view of a configuration of a storage subsystem according to an embodiment of the present invention.

FIG. 2(a) shows an example of a connection form of the storage subsystem according to an embodiment of the present invention.

FIG. 2(b) shows another example of a connection form of the storage subsystem according to an embodiment of the present invention.

FIG. 3 is a block diagram showing a functional configuration example of a controller according to an embodiment of the present invention.

FIG. 4 is a flowchart showing an operational example of the controller upon writing a file according to an embodiment of the present invention.

FIG. 5 is a flowchart showing an operational example of the controller upon reading a file according to an embodiment of the present invention.

FIG. 6 is a flowchart showing an operational example of an allowable energy calculating unit according to an embodiment of the present invention.

FIG. 7 is a flowchart showing a first operational example of the path retrieving unit 26 according to an embodiment of the present invention.

FIG. 8 is a flowchart showing a second operational example of the path retrieving unit 26 according to an embodiment of the present invention.

FIG. 9 is a flowchart showing a modified example of the second operational example of the path retrieving unit 26 according to an embodiment of the present invention.

FIG. 10 is a conceptual view of a first file copying method according to an embodiment of the present invention.

FIG. 11 is a conceptual view of a second file copying method according to an embodiment of the present invention.

FIG. 12 is a detailed view of the second file copying method according to an embodiment of the present invention.

FIG. 13 is a graph showing copying conditions in the second file copying method according to an embodiment of the present invention.

FIG. 14 is a block diagram showing a functional configuration example of a file read unit according to an embodiment of the present invention.

FIG. 15 is a flowchart showing an operational example of the file read unit upon controlling file copying according to an embodiment of the present invention.

FIG. 16 is a flowchart showing an operational example of the file read unit determining the file address from which copying is started, according to an embodiment of the present invention.

FIG. 17 shows a hardware configuration of a computer to which an embodiment of the present invention is applicable.

### DETAILED DESCRIPTION

Hereinafter, best modes for carrying out the present invention (hereinafter referred to as “embodiments”) will be described in detail with reference to the accompanying drawings. The present invention is applicable to, for example, a storage system of a grid structure as well as a multi-tiered storage system described above in the background art. The following description is directed to the multi-tiered storage system for illustrative purposes.

Problems of conventional multi-tiered storage systems are described.

First, consider the case where a file to be accessed exists in a tier logically far from a file access point (for example, tier 4). In this case, to access the file from the file access point, it is necessary to move the file up to a tier including the file access point (for example, tier 1). However, moving the file leads to a problem of consuming resources of tiers (for example, tiers 2 and 3) existing between these tiers and energy to use the resources.

Second, if multiple file accesses are made at a time, the file access point becomes a bottleneck.

Third, consider the case where multiple file accesses are made at a time with different requirements for performance. Here, the term different requirements for performance means, for example, a situation such that a high data transfer rate should be secured for one file access but not secured for the other file access. In this case, there arises a problem that the file access point should have a load balancing function in order to optimally arrange system resources in accordance with the requirements.

All the problems occur due to a single file access point in the multi-tiered storage system. Thus, this embodiment employs the following configuration.

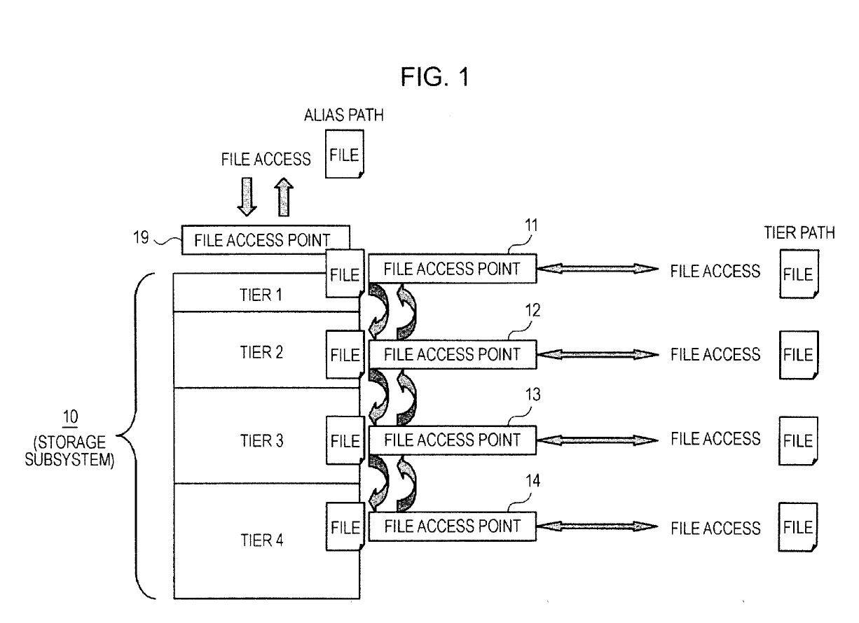

FIG. 1 is a conceptual view of a multi-tiered storage system (hereinafter simply referred to as “storage subsystem”) 10 of this embodiment.

In this embodiment, as shown in FIG. 1, file access points are provided for each tier in a one-to-one correspondence. That is, a file access point 11 is provided for a file on a tier 1. A file access point 12 is provided for a file on a tier 2. A file access point 13 is provided for a file on a tier 3. A file access point 14 is provided for a file on a tier 4. Therefore, accesses can be selectively made to the files on each tier.

Further, in this embodiment, similar to a conventional multi-tiered storage system, a file access point 19 is also provided, which enables file accesses irrespective of tier configuration.

In the following description, a path corresponding to the former file access point is referred to as “tier path” and a path corresponding to the latter file access point is referred to as “alias path”.

The storage subsystem 10 of this embodiment has such a configuration and thus has the following aspects.

In one aspect, even if a file to be accessed exists in a tier logically far from a file access point (for example, tier 4), accesses can be made to a file using file access points set for each tier. Accordingly, there is an effect of saving resources of tiers existing between the highest tier and a target tier.

In another aspect, the storage subsystem 10 copies or moves a file written from the alias path to a lower tier in accordance with a preset policy. This causes the following effect: whichever file access point is used to write a new file to the storage subsystem 10 from the tier path, the file can be copied or moved to a lower tier in accordance with a preset policy similar to the file written from the alias path.

In yet another aspect, even if multiple file accesses are made at a time, a file as a target for access can be accessed through a file access point of a tier including the file. As a result, the file accesses can be distributed, leading to an effect of avoiding a situation such that the file access point of the alias path becomes a bottleneck.

In yet another aspect, consider the case where multiple file accesses are made at a time with different requirements for performance. Here, the term different requirements for performance means, for example, a situation such that a high data transfer rate should be secured for one file access but not secured for another file access. In this case, the following effect can be attained: if the files exist in multiple tiers, system resources can be optimally utilized for file accesses by accessing a file in a tier meeting a predetermined requirement through a file access point of the tier. Further, even if file accesses are made with the same requirement for performance, the accesses are distributed to multiple tiers to thereby optimize file access performance as a whole.

How to connect the storage subsystem 10 of FIG. 1 with a controller 20 for controlling the storage subsystem 10 is described.

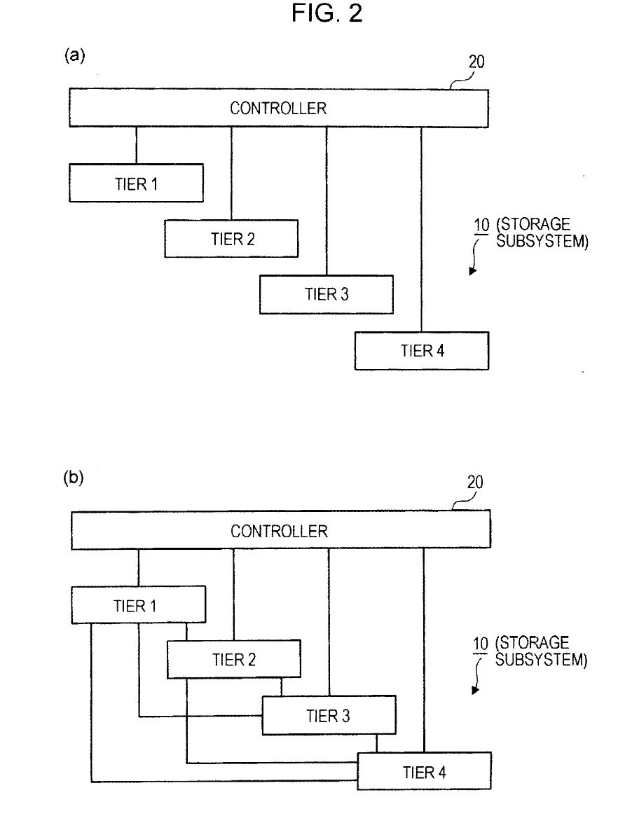

FIG. 2 shows examples of the connection form.

In the examples of FIG. 2, the storage subsystem 10 is configured with tiers 1 to 4. Further, the controller 20 may be, for example, a PC (personal computer), which is connected to a host (not shown) through a network (not shown).

Here, tiers 1 to 4 of the storage subsystem 10 are connected with the controller 20 as shown in FIG. 2(a) and FIG. 2(b), for example.

As shown in FIG. 2(a), each tier of the storage subsystem 10 is connected to only the controller 20. In this case, data should be moved between the two tiers through the controller 20.

As shown in FIG. 2(b), each tier in the storage subsystem 10 is connected to not only the controller 20 but also the other tiers. In this case, data is moved between the two tiers through two paths. One path passes through the controller 20, and the other path is a direct one. Which path is selected to move data between tiers varies depending on the following conditions, for example.

If any data access may be made from an external device after or during data movement, the path passing through the controller 20 is selected. This is to bring external data accesses and accesses to tiers upon data movement into one access.

If the above condition is not satisfied, the direct path is selected.

The connection form shown in FIG. 2(a) may be considered a subset of the connection form shown in FIG. 2(b).

In this embodiment, multiple tiers may include multiple copies of the same file. To determine an identity of the multiple copies, a file identifier (FileIdentifier) for uniquely identifying copies in the storage subsystem 10 is used.

Further, a file access path (FileAccessPath) is path information for file access.

The file access is made using the file access path and the file identifier in combination. For example, if the file access path is “/tier1/” and the file identifier is “GID0010”, the file access is made by designating “/tier1/GID0010”. Consider the case where multiple file access paths for example, “/tier1/”, “/tier2/”, and “/tier3/” exist. In this case, accesses are made to the same file through the file access paths by designating “/tier1/GID0010”, “/tier2/GID0010”, and “/tier3/GID0010”.

In this embodiment, file access points are set for each tier as shown in FIG. 1. In this configuration, the following means are provided. In the description, the term “means” refers to any prepared procedure. For example, a function may be used.

In one aspect, this embodiment provides a mechanism for determining the optimum file access point of a tier to store a file in accordance with a request to access the file and allowable energy consumption of the system. The mechanism is referred to as GetWriteAccessPoint means in the following description. For example, in the case of designating a period up to the next use of the file as file attributes, a file access point of a tier, which is suitable to store the file, can be determined. If any tier is put in a power save mode, a file access point suitable to store the file can be selected from tiers in a normal mode.

The GetWriteAccessPoint means is described in detail next.

The GetWriteAccessPoint means is used to determine a file access point to write a file. This means is executed prior to an operation of writing the file through the file access point. The GetWriteAccessPoint means can be expressed as follows with GetWriteAccessPoint set as the function and FileAccessPoint as a return value.

FileAccessPoint=GetWriteAccessPoint (FileWriteAccessFactor, SystemWriteOperationFactor)

Here, FileWriteAccessFactor refers to a file access requirement such as the minimum data transfer rate, band assurance/not-assurance, a delay time until the start of data transfer, a period until the next access, or a file size.

Further, SystemWriteOperationFactor includes an access priority, a system priority, and the like.

Among those, an access priority refers to a write priority of the file—that is, a priority given in the case where multiple files are written at a time. The high-priority file is written earlier than low-priority files.

In addition, a system priority refers to a priority regarding additional energy consumption for writing the file. The higher the priority, the more additional energy is consumed to meet the file access requirements. On the other hand, if the priority is low, the file is written in accordance with the file access requirements that can be met within an allowable amount of energy consumption. In this example, the priority is adopted as an example of information that represents preference.

SystemWriteOperationFactor is generally designated by a user of a host. For example, the following case is conceivable: an amount of additional energy consumption is controlled based on how much power is consumed at a place where the storage subsystem 10 is set or how much heat is generated as a result of consuming the power. In such a case, an amount of additional energy may be changed under the control in accordance with the power consumption or heat generation. Thus, a user designates the amount using SystemWriteOperationFactor.

Further, FileAccessPoint includes both a path name and a file identifier.

In another aspect, this embodiment offers a mechanism for determining a file access point suitable to read a file in accordance with a requirement about file access and an allowable energy consumption amount of the system in the case where the storage subsystem 10 includes one or more copies of the file. This mechanism is referred to as GetReadAccessPoint means in the following description. For example, consider the case where accesses are concentrated to a certain tier and then, performance might be lowered. In this case, if the other tier includes a copy of a file to be read, performance of the entire system can be optimized using file access points of multiple tiers.

The GetReadAccessPoint means is described in more detail next.

The GetReadAccessPoint means is used to determine a file access point to read a file. This means is executed prior to an operation of reading a file through the file access point. The GetReadAccessPoint means can be expressed as follows with GetReadAccessPoint set as the function and FileAccessPoint set as a return value.

FileAccessPoint=GetReadAccessPoint (FileIdentifier, FileReadAccessFactor, SystemReadOperationFactor)

Here, FileIdentifier is a single file identifier in the storage subsystem 10. FileReadAccessFactor refers to a file access requirement such as the minimum data transfer rate, band assurance/not-assurance, a delay time until the start of data transfer, or a file size.

Further, SystemReadOperationFactor includes an access priority, a system priority, and the like.

Among those, an access priority refers to a read priority of the file—that is, a priority given in the case where multiple files are read at a time. The high-priority file is read earlier than low-priority files.

In addition, a system priority refers to a priority regarding additional energy consumption for reading the file. The higher the priority, the more additional energy is consumed to meet the file access requirements. On the other hand, if the priority is low, the file is read in accordance with the file access requirements that can be met within an allowable amount of energy consumption. In this example, the priority is adopted as an example of information that represents preference.

SystemReadOperationFactor is generally designated by a user of a host. For example, the following case is conceivable: an amount of additional energy consumption is controlled based on how much power is consumed at a place where the storage subsystem 10 is set or how much heat is generated as a result of consuming the power. In such a case, an amount of additional energy may be changed under the control in accordance with the power consumption or heat generation. Thus, a user designates the amount using SystemReadOperationFactor.

In yet another aspect, this embodiment offers a mechanism for obtaining current file access requirements of a designated tier path. The mechanism corresponds to the GetReadAccessFactor means/GetWriteAccessFactor means and GetReadOperationFactor means/GetWriteOperationFactor means.

First, the GetReadAccessFactor means and the GetWriteAccessFactor means are described.

The GetReadAccessFactor means and the GetWriteAccessFactor means are to designate a file access point and a system priority to obtain file access requirements. That is, if a file access point including a file identifier is designated, the means obtains the FileReadAccessFactor or FileWriteAccessFactor in accordance with priorities based on the system priority designated at the time of obtaining the file access point.

Next, the GetReadOperationFactor means and the GetWriteOperationFactor means are described.

The GetReadOperationFactor means and the GetWriteOperationFactor means are to designate a file access point and file access requirements to obtain data about a requisite amount of additional energy consumption. That is, if a file access point including a file identifier is designated, the means obtains data about a current estimated amount of additional energy consumption that is necessary for realizing the FileReadAccessFactor or FileWriteAccessFactor at the time of determining the file access point.

To give a specific example of this embodiment, a patient's data storage device is described next.

In the patient's data storage device, test data can be accessed using a patient's name as a key. The possibility of accessing the test data obtained upon physical examination of a patient is lowered in the chronological order. As a result, a tier to store the test data is changed. However, as for the file access through the alias path as shown in FIG. 1, a file is transparently passed through the tier configuration.

The reason the possibility of accessing the test data obtained upon physical examination of a patient is lowered in the chronological order is as follows.

The possibility of referencing the data is very high during or just after the input of the test data because the data is used to examine a patient. Such data is desirably stored in tier 1 in FIG. 1.

After an elapse of, for example, 1 month after the input of the test data, the possibility of examining the patient based on the test data is not high compared with just after the examination. However, in order to respond to a rapid change in medical condition, the test data is desirably stored in tier 1 or tier 2.

After an elapse of, for example, 1 year, it is still necessary to check the data upon routine checkup of the patient in order to compare the data with current test data. However, the need for access is decreased. Accordingly, no problem arises if the test data is stored in tier 3.

After an elapse of, for example, three years, the test data is rarely used, and the possibility of referencing the test data upon medical checkup for the patient is low. Hence, no problem arises if the test data is stored in tier 4.

In the above case, a frequency of access to test data is evaluated with individual patients as a target of examination used as a key. Meanwhile, there is a possibility that a need for data mining for all patients arises. For example, there may be a case where data about reactions to drugs used for a particular disease or effects thereof are collected and organized. Accesses to the test data for that purpose do not match with the accesses based on the above placement of test data. That is, to enable the accesses to the test data for that purpose, another accessing method is required in addition to an accessing method using a single access point like a conventional one; the additional method does not affect the accessing method.

This embodiment provides a method of adding a file access point for each tier—that is, a method of accessing a file through the tier path of FIG. 1 as the accessing method.

The above is described below by way of specific examples.

In FIG. 1, different path names are given for each tier as a logical file access point.

For example, a path for tier 1 is set as “/tier1/”, a path for tier 2 is set as “/tier2/”, a path for tier 3 is set as “/tier3/”, and a path for tier 4 is set as “/tier4/”.

At this time, a file written to the storage subsystem 10 is given a global ID that is a single name in the storage subsystem 10. From then on, the file is identified with the global ID. Even if the file is moved or copied between tiers, the given global ID is not changed.

For example, consider the case where the global ID of the file is “GID0010”, and a copy of the file is stored in tiers 1, 2, and 3. In this case, the file is identified as follows through each tier. That is, the path for tier 1 identifies the file as “/tier1/GID0010”, the path for tier 2 identifies the file as “/tier2/GID0010”, and the path for tier 3 identifies the file as “/tier3/GID0010”. These paths can be obtained with file all-path determining means.

Further, in this embodiment, the above file accesses for data mining are made through the tier path of a tier logically far from the alias path in less urgent situations. Thus, an influence of the file accesses through the alias path is minimized. Further, an allowable amount of requisite additional energy is designated to thereby enable an access in consideration of energy consumption.

Next, the controller 20 for realizing the above operation is described.

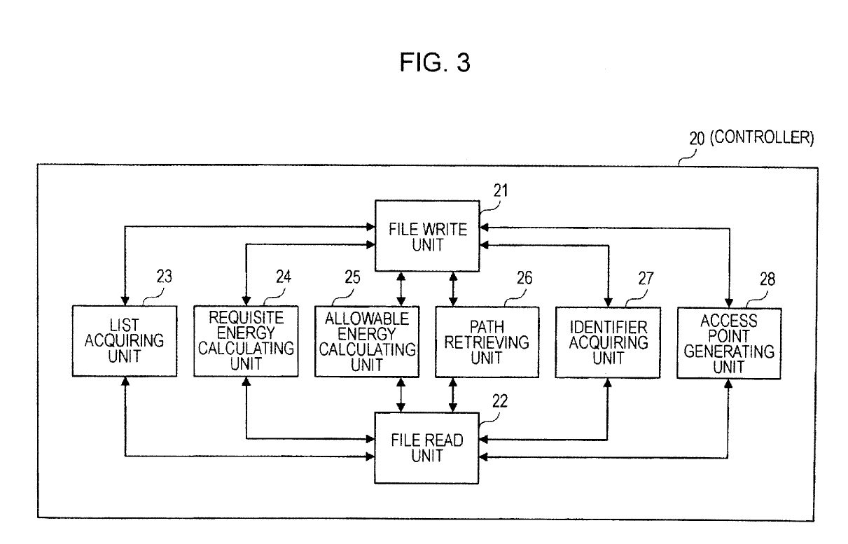

FIG. 3 is a block diagram showing a functional configuration example of the controller 20.

As shown in FIG. 3, the controller 20 includes a file write unit 21, a file read unit 22, a list acquiring unit 23, a requisite energy calculating unit 24, an allowable energy calculating unit 25, a path retrieving unit 26, an identifier acquiring unit 27, and an access point generating unit 28.

The file write unit 21 writes a designated file to any tier. At this time, a file access point used to write the file is obtained by controlling the list acquiring unit 23, the requisite energy calculating unit 24, the allowable energy calculating unit 25, the path retrieving unit 26, the identifier acquiring unit 27, and the access point generating unit 28. In this embodiment, the file write unit 21 is provided as an example of a write unit for writing data.

The file read unit 22 reads a designated file from any tier. At this time, a file access point used to read the file is obtained by controlling the list acquiring unit 23, the requisite energy calculating unit 24, the allowable energy calculating unit 25, the path retrieving unit 26, the identifier acquiring unit 27, and the access point generating unit 28. In this embodiment, the file read unit 22 is provided as an example of a read unit for reading data.

The list acquiring unit 23 obtains a list of tiers that meet designated file access requirements. To be specific, the list acquiring unit 23 obtains a tier list by storing a performance table summarizing transfer speeds and access speeds of each tier and searching the performance table for a tier that meets designated file access requirements. For example, if the minimum data transfer rate is designated as a file access requirement, the list acquiring unit 23 obtains a list of tiers having a transfer rate not lower than the data transfer rate.

The requisite energy calculating unit 24 calculates an additional energy amount necessary to satisfy designated file access requirements for each tier in the tier list. Here, the additional energy amount means an amount of additional energy relative to current energy consumption. For example, the amount is an additional energy amount necessary to shift the tier from a power save mode to a normal mode in order to meet the file access requirements. In this embodiment, the requisite energy calculating unit 24 is provided as an example of a first acquiring unit for acquiring first information representing a requisite energy amount.

The allowable energy calculating unit 25 calculates an allowable additional energy amount based on the preference corresponding to the system priority. In this embodiment, the allowable energy calculating unit 25 is provided as an example of a second acquiring unit for acquiring second information representing an allowable energy amount.

The path retrieving unit 26 determines a path for a tier suitable to write or read a file based on a requisite amount of additional energy calculated by the requisite energy calculating unit 24 and an allowable amount of additional energy calculated by the allowable energy calculating unit 25. In this embodiment, the file access path is used as an example of information for specifying a storage area as a target for access, and the path retrieving unit 26 is provided as an example of a selecting unit for selecting the storage area as a target for access.

The identifier acquiring unit 27 obtains a file identifier of a designated file.

The access point generating unit 28 generates a file access point based on the path obtained with the path retrieving unit 26 and the file identifier obtained with the identifier acquiring unit 27. In this embodiment, the file access point is used as an example of positional information for specifying a data write position or read position, and the access point generating unit 28 is provided as an example of a generating unit for generating positional information.

Next, operations of the controller 20 are described.

First, a process for determining a file access point (GetWriteAccessPoint) at the time of writing a file is described. In this processing, FileWriteAccessFactor and SystemWriteOperationFactor are designated as parameters. Further, this processing is carried out under the control of the file write unit 21. In the following description, this control is omitted for ease of explanation.

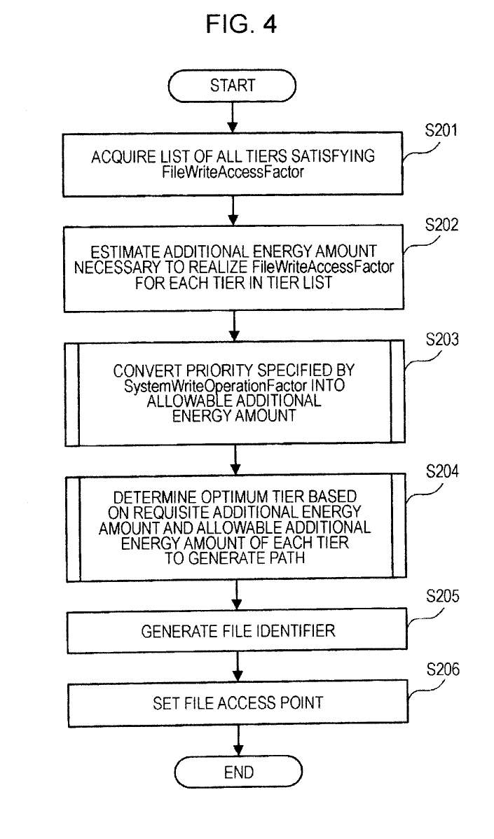

FIG. 4 is a flowchart showing an operational example of the controller 20.

In response to the operation, the list acquiring unit 23 first obtains a list of tiers (tier list) that can satisfy FileWriteAccessFactor (step 201). The storage subsystem 10 of this embodiment has different capacities and/or access characteristics for each tier. For example, timing-critical data accesses are required depending on job requirements. In this case, even though a tier of a normal mode exists, if the tier cannot meet job requirements, the other tiers that meet the requirements need to be selected. Thus, only tiers meeting the file access requirements are selected.

Next, the requisite energy calculating unit 24 estimates an amount of additional energy necessary to realize FileWriteAccessFactor for each tier in the tier list (step 202). The estimate can be obtained by a calculation based on a setting change of a power management function of a target device. In this case, a requisite amount of energy is defined beforehand in accordance with changes in settings of the power management function, for example, and the energy is estimated based on the definition. For example, in an electric circuit as a main component whose power is mainly consumed by a storage device, a clock frequency is controlled to control the energy consumption. Thus, an amount of energy consumption is defined in accordance with a clock frequency to estimate an energy amount. In another example, in a magnetic medium driving device or a head driving device as another main component whose power is mainly consumed by a storage device, an acceleration upon driving or steady-state speed is controlled to control energy consumption. Therefore, an amount of energy is defined in accordance with a preset speed to estimate an energy amount.

On the other hand, the allowable energy calculating unit 25 converts a priority specified by SystemWriteOperationFactor into an allowable amount of additional energy (allowable additional energy amount) (step 203). A coefficient, etc., used for the conversion is set in advance.

After that, the path retrieving unit 26 determines the optimum tier based on the requisite amount of additional energy estimated in step 202 and the allowable additional energy amount converted from the preference in step 203. Then, the path retrieving unit 26 unit generates a path corresponding to the tier (step 204).

Further, the identifier acquiring unit 27 generates a file identifier (step 205).

Finally, the access point generating unit 28 combines the path generated in step 204 and the file identifier generated in step 205 to generate a file access point (step 206).

Next, the process for determining a file access point (GetReadAccessPoint) upon reading a file is described. In this processing, in addition to FileReadAccessFactor and SystemReadOperationFactor, a file identifier for identifying a file to be read is designated as a parameter. This processing is executed on assumption that multiple copies of the file to be read exist in multiple tiers. Further, this processing is performed under the control of the file read unit 22, but this control is not described here for ease of explanation.

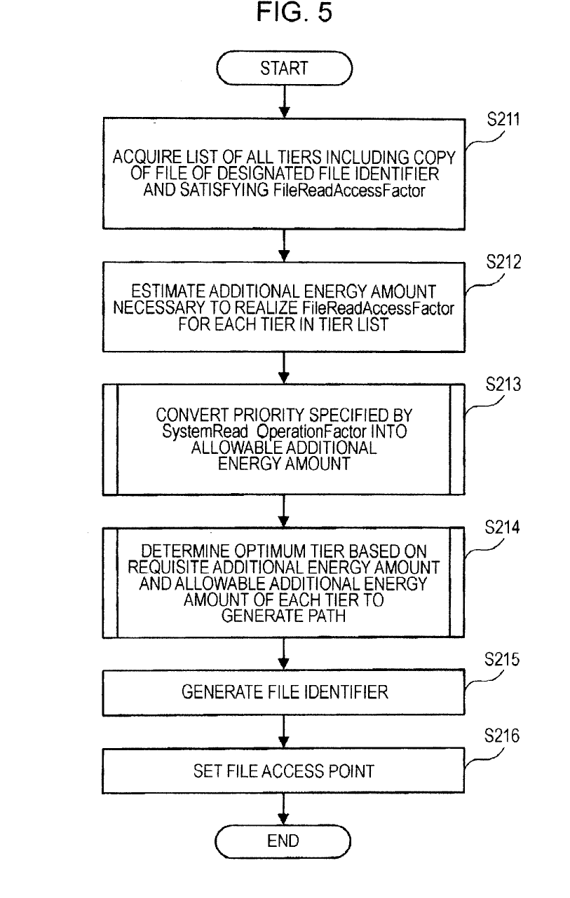

FIG. 5 is a flowchart showing an operational example of the controller 20.

In response to the operation, the list acquiring unit 23 first obtains a list of tiers (tier list) that include a copy of a file corresponding to a designated file identifier and can satisfy FileReadAccessFactor (step 211). In this example, a list of the tiers including a copy of a file corresponding to a designated file identifier may be obtained based on a management table that describes each file in association with a tier including its copies. The storage subsystem 10 of this embodiment has different capacities and/or access characteristics for each tier. For example, timing-critical data accesses are required depending on job requirements. In this case, even though a tier of a normal mode exists, if the tier cannot meet job requirements, the other tiers that meet the requirements need to be selected. Thus, only tiers meeting the file access requirements are selected.

Next, the requisite energy calculating unit 24 estimates an amount of additional energy necessary to realize FileReadAccessFactor for each tier in the tier list (step 212). The estimate can be obtained by calculation based on a setting change of a power management function of a target device. In this case, a requisite amount of energy is defined beforehand in accordance with changes in settings of the power management function, for example, and the energy is estimated based on the definition. For example, in an electric circuit as a main component whose power is mainly consumed by a storage device, a clock frequency is controlled to thereby control the energy consumption. Thus, an amount of energy consumption is defined in accordance with a clock frequency to thereby estimate an energy amount. In another example, in a magnetic medium driving device or a head driving device as another main component whose power is mainly consumed by a storage device, an acceleration upon driving or steady-state speed is controlled to control energy consumption. Therefore, an amount of energy is defined in accordance with a preset speed to estimate an energy amount.

On the other hand, the allowable energy calculating unit 25 converts a priority specified by SystemReadOperationFactor into an allowable amount of additional energy (allowable additional energy amount) (step 213). A coefficient, etc., used for the conversion is set in advance.

After that, the path retrieving unit 26 determines the optimum tier based on the requisite amount of additional energy estimated in step 212 and the allowable additional energy amount converted from the preference in step 213. Then, the path retrieving unit 26 generates a path corresponding to the tier (step 214).

Further, the identifier acquiring unit 27 generates a file identifier (step 215).

Finally, the access point generating unit 28 combines the path generated in step 214 and the file identifier generated in step 215 to generate a file access point (step 216).

Here, a process for calculating the allowable amount of additional energy in step 203 of FIG. 4 and step 213 of FIG. 5 is described next.

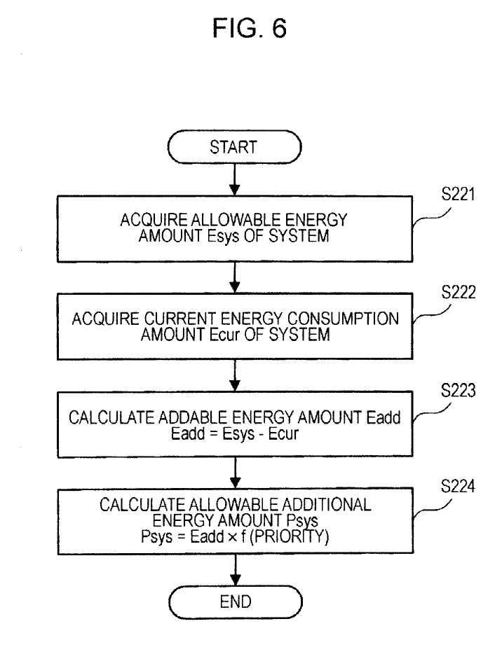

FIG. 6 is a flowchart showing an operational example of the allowable energy calculating unit 25 in this case.

In response to the operation, the allowable energy calculating unit 25 calculates an allowable energy amount Esys of the system (step 221). The allowable energy calculating unit 25 calculates a current energy consumption amount Ecur of the system (step 222) and subtracts Ecur from Esys to determine an addable energy amount Eadd (step 223).

After that, the allowable energy calculating unit 25 multiplies Eadd by f(priority) to calculate an allowable additional energy amount Psys (step 224). In this example, f is a function for determining a conversion factor of the allowable additional energy amount based on the preference specified by the system priority. The system priority is given as SystemWriteOperationFactor in FIG. 4 and as SystemReadOperationFactor in FIG. 5. In this case, the obtained conversion factor is 0 to 1.

Further, a process for generating a path in step 204 of FIG. 4 and step 214 of FIG. 5 is described.

As described above, in these steps, for example, a tier with a requisite amount of additional energy below an allowable additional energy amount is determined as the optimum tier. For example, assuming that tiers of different modes, a normal mode and a power save mode, meet the file access requirements, an additional energy amount can be reduced by accessing a file in a tier in the normal mode rather than by returning from the power save mode to the normal mode for file access, except in special circumstances. Therefore, in general, any one of the tiers in the normal mode is selected as the optimum one.

However, if all tiers meeting the file access requirements are in the power save mode, a problem occurs; that is, a large amount of additional energy is necessary to return the tier from the power save mode to the normal mode, so it is necessary to determine whether or not the amount can be within a range of the allowable energy amount.

To that end, operations for a path generating process are described assuming that all tiers meeting file access requirements are in the power save mode.

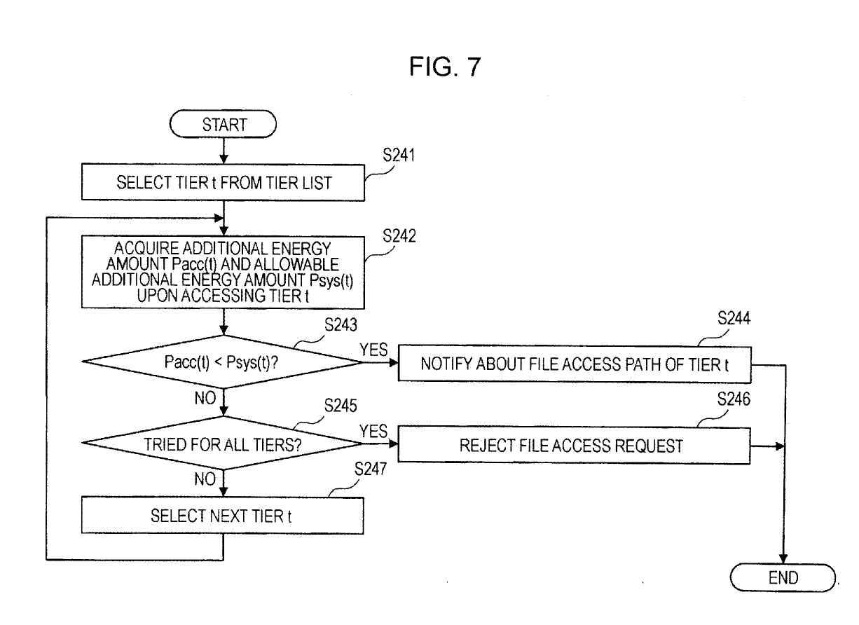

FIG. 7 is a flowchart showing a first operational example of the path retrieving unit 26 in this case. In the first operational example, an access is permitted if an estimated amount of additional energy for accesses is not larger than the allowable additional energy amount and otherwise rejected.

In response to the operation, the path retrieving unit 26 first selects a tier t in the tier list (step 241). Then, the processing in steps 242 to 246 is performed on the selected tier t.

That is, the path retrieving unit 26 first calculates an additional energy amount Pacc(t) necessary for accessing tier t and an allowable additional energy amount Psys(t) converted from the preference (step 242). As for Pacc(t), the additional energy amount estimated in step 202 of FIG. 4 or step 212 of FIG. 5 is obtained. Further, as for Psys(t), the allowable additional energy amount calculated in step 224 of FIG. 6 is obtained.

Next, the path retrieving unit 26 compares the requisite additional energy amount Pacc(t) with the allowable additional energy amount Psys(t) (step 243).

As a result, if the requisite additional energy amount Pacc(t) is smaller than the allowable additional energy amount Psys(t), a file access path of the selected tier t is notified for the final procedure of generating a path (step 244).

On the other hand, if the requisite additional energy amount Pacc(t) is not smaller than the allowable additional energy amount Psys(t), it is determined whether or not all tiers in the tier list are evaluated (step 245). If all tiers have been evaluated, there is no free file access path, so file access is not permitted (step 246). Further, if all tiers have not been evaluated, the next tier t is selected (step 247) and processing in steps 242 to 246 is repeated.

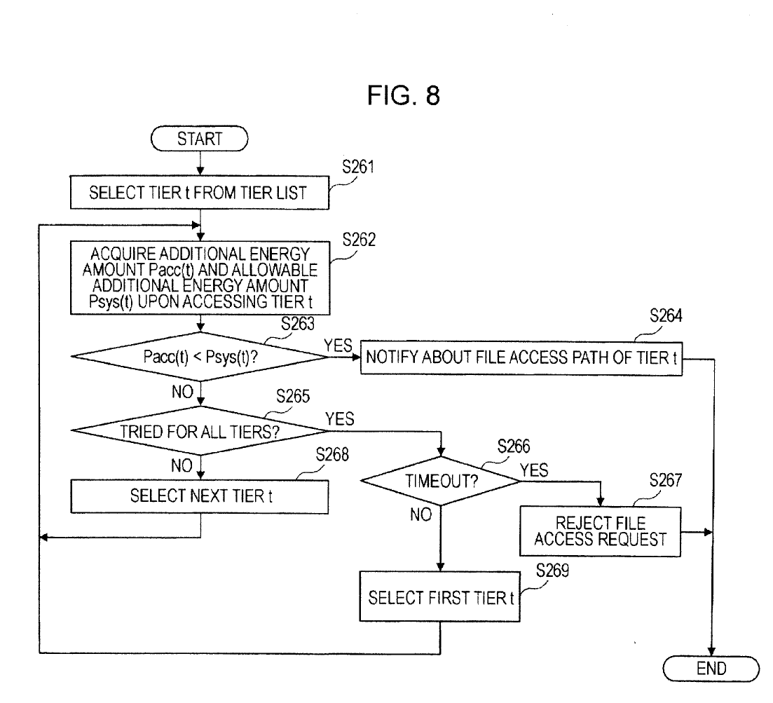

FIG. 8 is a flowchart showing a second operational example of the path retrieving unit 26. In the second operational example, an access is permitted if an estimated amount of additional energy for accesses is not larger than the allowable additional energy amount; otherwise, a process for calculating an allowable additional energy amount and checking the operation based on the amount is continued until the timeout.

In response to the operation, the path retrieving unit 26 first selects a tier t in the tier list (step 261). Then, the processing in steps 262 to 266 is performed on the selected tier t.

That is, the path retrieving unit 26 first calculates an additional energy amount Pacc(t) necessary for accessing tier t and an allowable additional energy amount Psys(t) converted from the preference (step 262). As for Pacc(t), the additional energy amount estimated in step 202 of FIG. 4 or step 212 of FIG. 5 is obtained. Further, as for Psys(t), the allowable additional energy amount calculated in step 224 of FIG. 6 is obtained.

Next, the path retrieving unit 26 compares the requisite additional energy amount Pacc(t) with the allowable additional energy amount Psys(t) (step 263).

As a result, if the requisite additional energy amount Pacc(t) is smaller than the allowable additional energy amount Psys(t), a file access path of the selected tier t is notified for the final procedure of generating a path (step 264).

On the other hand, if the requisite additional energy amount Pacc(t) is not smaller than the allowable additional energy amount Psys(t), it is determined whether or not all tiers in the tier list are evaluated (step 265). If all tiers have been evaluated, it is determined whether or not timeout has occurred (step 266). If timeout has occurred, there is no free file access path, so file access is not permitted (step 267). Further, if all tiers have not been evaluated, the next tier t is selected (step 268) and processing in steps 262 to 266 is repeated. Further, if timeout has not occurred, the first tier t is selected (step 269) and processing returns to step 262.

In the second operational example, if timeout occurs in step 266, file access is not permitted in step 267. Here, the following case is conceivable as a modified example of the processing in step 267. That is, assuming that a tier (tier that is a target of file access) which meets file access requirements but is in a power save mode is found, and assuming in addition that another tier is operating in a normal mode and a lower-priority file access is made to the tier, the file access is stopped and the tier is forcedly shifted to the power save mode to thereby increase an allowable additional energy. Then, the tier that is a target of file access is shifted to a normal mode to perform file access.

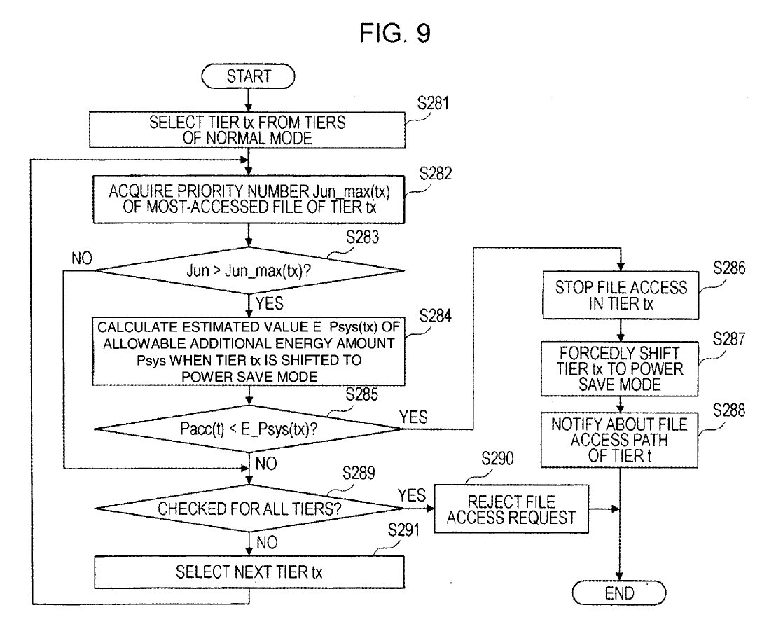

FIG. 9 is a flowchart showing an operational example of the path retrieving unit 26 in this case.

In response to the operation, the path retrieving unit 26 first generates a list of tiers operating in a normal mode and selects one tier tx from the tiers (step 281). Then, the path retrieving unit 26 performs processing in steps 282 to 290 on the selected tier tx.

That is, the path retrieving unit 26 obtains a number Jun_max(tx) of the highest-priority file access of the accesses to tier tx (step 282).

Next, the path retrieving unit 26 compares the number Jun of the priority of a current file access with the number Jun_max(tx) of the highest-priority file access to tier tx obtained in step 282 (step 283). If the number Jun of the priority of a current file access is smaller than the number Jun_max(tx) of the highest-priority file access to tier tx, the processing advances to step 289. On the other hand, if the number Jun of the priority of a current file access is larger than the number Jun_max(tx) of the highest-priority file access to tier tx, the path retrieving unit 26 calculates an estimated value E_Psys(tx) of the allowable additional energy amount Psys in the case where tier tx is shifted to the power save mode (step 284). Then, the path retrieving unit 26_compares the requisite additional energy amount calculated in step 262 of FIG. 8 with the estimated value E_Psys(tx) calculated in step 284 (step 285).

As a result, if the requisite additional energy amount is smaller than the estimated value E_Psys(tx), the path retrieving unit 26 stops file accesses to tier tx (step 286). Next, tier tx is forcedly shifted to the power save mode (step 287). Then, the file access path of tier t selected in step 261 of FIG. 8 is notified for the final procedure of generating a path (step 288).

On the other hand, if the requisite additional energy amount is not smaller than the estimated value E_Psys(tx), the path retrieving unit 26 determines whether or not all tiers in the tier list have been evaluated (step 289). If all tiers have been evaluated, there is no free file access path, so file access is not permitted (step 290). Further, if all tiers have not been evaluated, the next tier t is selected (step 291) and processing in steps 282 to 290 is repeated.

The above description is focused on how to determine a file access point in consideration of file access requirements and an allowable energy amount. However, the above description is given on assumption that file access points of tiers meeting file access requirements are obtained. In some cases, a file to be read is included in a tier that does not meet file access requirements but operates in a normal mode. In addition, a plurality of such tiers may exist. In this case, in order to meet particular requirements about data transfer speeds, data is partially read from multiple tiers and read data are combined in a buffer to realize a data transfer speed equivalent to that of a tier of a normal mode, which meets file access requirements.

Problems involved in copying of a file between tiers of a conventional multi-tiered storage system are described next. Since the conventional multi-tiered storage system is used as an example here, a file access point is set only in the highest-order tier 1, and the remaining tiers have no file access point.

A file written to tier 1 as the highest-order tier is copied to lower-order tiers under the control of the storage subsystem 10 or external control. Further, if tier 1 does not include a copy of a file at the time of receiving a request to transfer a file to an external device, a copy of a file existing in tier 2 or subsequent tiers is copied to tier 1 and the file is transferred from tier 1. In the conventional multi-tiered storage system, even if a file is copied to tier 1 from tier 1 or subsequent tiers, a file is copied only from a tier designated as a copy source at that time. This leads to a problem that performance of the tier as a copy source influences the end time of file transfer from tier 1.

To overcome the problem, an embodiment of the present invention provides means for copying a file to a higher-order tier using a file existing in multiple lower-order tiers at the time of copying the file to the higher-order tier.

In the case of transferring a file from the higher-order tier, the transfer performance is not directly influenced by the performance of a particular lower-order tier. That is, even if any lower-order tier is in the power save mode and thus is low in performance, the whole performance can be kept high by accessing multiple files in the lower-order tiers.

To give specific examples, this embodiment employs the following methods. A first method is to select a source of file copying to any higher-order tier from multiple lower-order tiers.

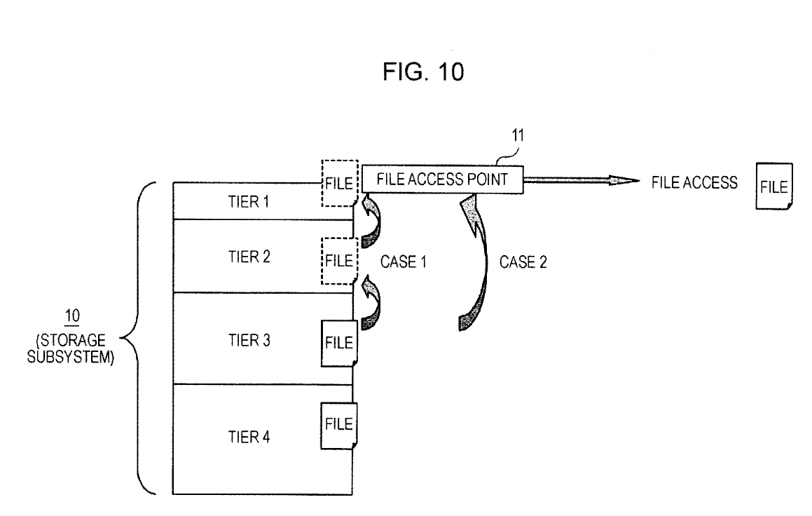

FIG. 10 shows how to copy a file with this method. In this case, similar to the above, although each tier includes file access points, only the file access point 11 used for finally reading the file is illustrated in FIG. 10.

Further, in this example, neither tier 1 nor tier 2 includes a copy of the file, and tiers 3 and 4 include a copy of the file. As shown in Case 1 of FIG. 10, the file is first copied to tier 2 from tier 3 and then copied from tier 2 to tier 1. In this way, the file is copied to tier 1. This is a copying method employed in the conventional multi-tiered storage system. This embodiment also employs a method of directly copying the file of tier 3 to tier 1 to enable transfer of the file to an external device in addition to the above method as shown in Case 2 of FIG. 10. Alternatively, files of tier 4 as well as tier 3 may be used as a copy source.

Whether to copy a file in accordance with the conventional copying method or directly copy a file from a lower-order tier to the highest-order tier can be determined under the control of the storage subsystem 10 or external control.

A second method is to combine copies of files in multiple lower-order tiers to generate a copy of the file in the higher-order tier.

In an embodiment of the present invention, data is copied from a plurality of storage areas. That is, an embodiment of the present invention also provides a device for controlling data copying in a storage device having a plurality of storage areas, including: a selecting unit for selecting the plurality of storage areas, each storing one of a plurality of copies of the data; and a control unit for executing control such that a plurality of different portions of the plurality of copies of the data stored in the plurality of storage areas selected by the selecting unit are copied and combined in a predetermined storage area of the plurality of storage areas.

Further, in this device, the selecting unit may select a particular storage area for storing a copy of the data from the plurality of storage areas, and may select a storage area from the plurality of storage areas except the particular storage area in accordance with an estimated copy completion time for the copy to a predetermined storage area.

Further, the selecting unit may determine a copy start position in the copy stored in a storage area other than the particular storage area, and the control unit may execute control to start copying of the copy from the copy start position determined by the selecting unit.

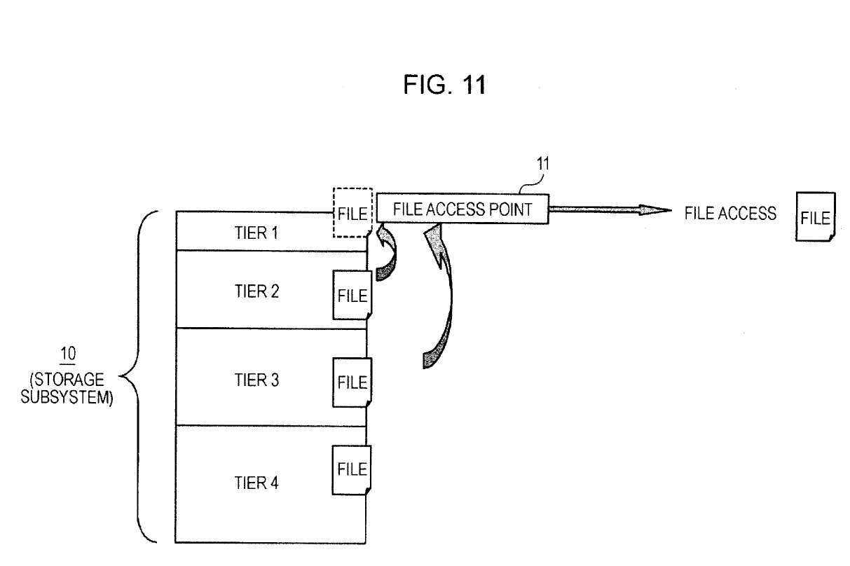

FIG. 11 shows how to combine copies of files in tiers 2 and 3 to generate a copy in tier 1. In this case, similar to the above in FIG. 10, each tier includes file access points, but only the file access point 11 used for finally reading the file is illustrated in FIG. 10.

Further, in this example, tier 1 does not include a copy of the file, and tiers 2 and 3 include a copy of the file. In this case, a file is copied to tier 1 using copies of files in tiers 2 and 3 to enable file transfer to an external device.

The copying method of FIG. 11 is executed by copying data from tiers 2 and 3 to a buffer memory or a copy destination file on tier 1.

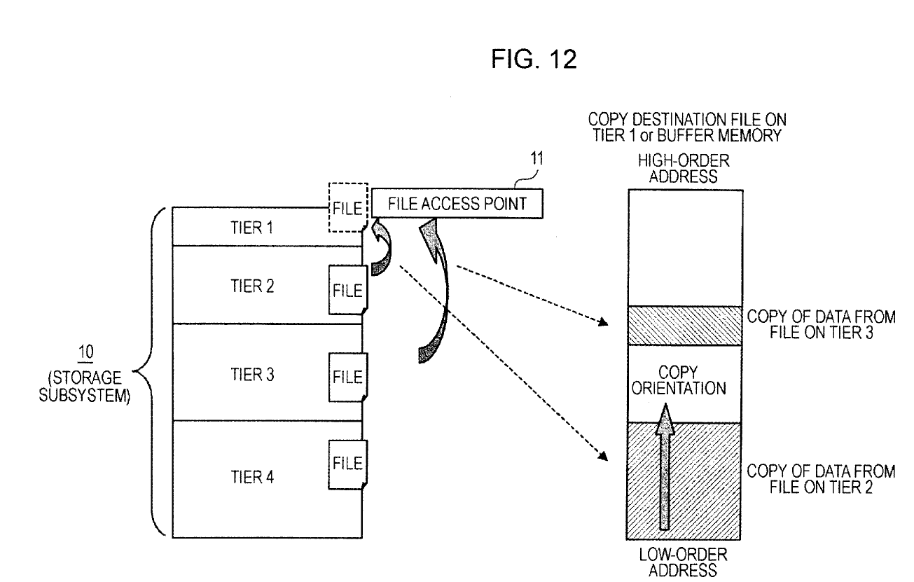

FIG. 12 shows how to combine copies of files in multiple lower-order tiers to generate a copy of the file.

As shown in FIG. 12, data is copied from a file on tier 2 to a file on tier 1 or a buffer memory. At the same time, a part of the data, which is not copied from tier 2, is copied from a file on tier 3. Alternatively, a copy of a file on tier 4 as well as copies of files on tiers 2 and 3 can be stored in a buffer memory or file on tier 1.

Next, specific aspects of a copying process based on the methods of FIGS. 11 and 12 are described.

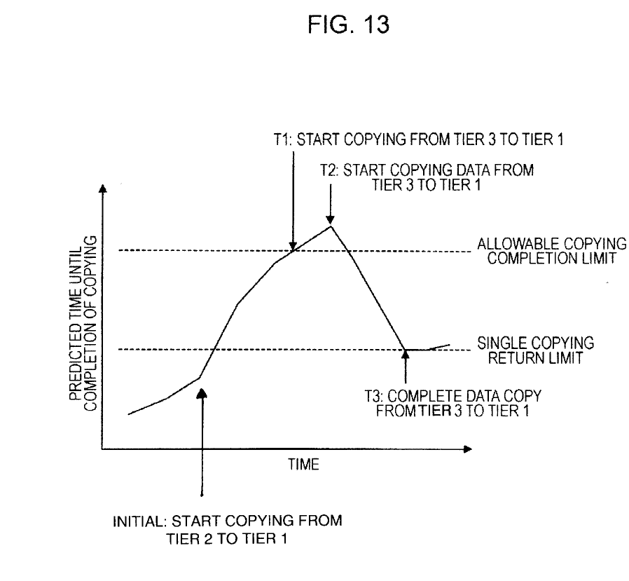

FIG. 13 shows specific aspects of a copying process.

In FIG. 13, at the initial stage, data is copied from tier 2 to tier 1. In this case, a speed of data copying from tier 2 to tier 1 is monitored, and a period until the completion of data copying is estimated based on the data copying speed.

If the data copying speed lowers due to various factors, an estimated period until the completion of data copying is increased and exceeds the allowable limit of completion of copying at time T1. To describe a possible scenario, tier 2 is put in a power save mode. At this time, data is copied from tier 3 to tier 1. Then, after the delay time T2-T1, data copying from tier 3 to tier 1 is started. As the data copying is started, the speed of data transfer to tier 1 is increased.

Since the speed of data transfer to tier 1 is increased, an estimated period until the completion of data copying is shortened, and a single copying return limit is reached at time T3. As a result, data copying from tier 3 to tier 1 is completed and processing is shifted to single data copying from tier 2 to tier 1 again.

Whether to stop copying data from tier 2 at time T3 may be determined in accordance with a utilization rate of system resources for file transfer from tier 1 to the outside. That is, unless the system resources necessary for copying a file from tier 3 to tier 1 would be used for another purpose, the file copying is continued directly from tier 3.

Next, the file read unit 22 for realizing the above operation (see FIG. 3) is described.

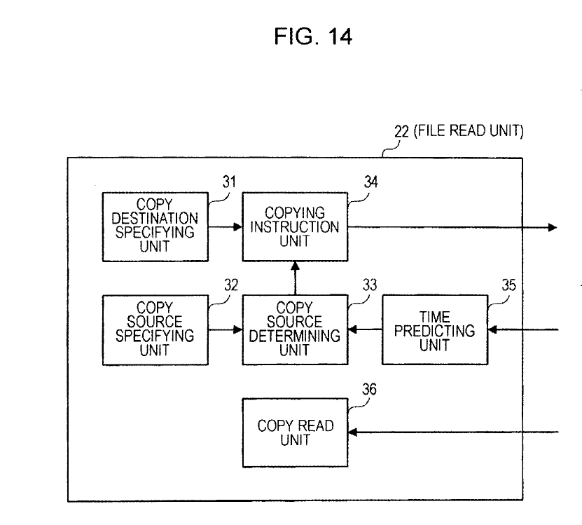

FIG. 14 is a block diagram showing a functional configuration example of the file read unit 22.

As shown in FIG. 14, the file read unit 22 includes a copy destination specifying unit 31, a copy source specifying unit 32, a copy source determining unit 33, a copying instruction unit 34, a time predicting unit 35, and a copy read unit 36.

The copy destination specifying unit 31 specifies a tier to which a copy of a file is stored.

The copy source specifying unit 32 obtains a list of tiers storing a copy as a source of file copy.

The copy source determining unit 33 selects a copy source tier from a list of tiers specified by the copy source specifying unit 32.

The copying instruction unit 34 instructs a copy source tier and/or a copy destination tier to copy file data from the copy source tier to the copy destination tier.

The time predicting unit 35 estimates a period until the completion of copying and sends the estimation result to the copy source determining unit 33. Here, the time predicting unit 35 can calculate a current copying speed of a part of the file to estimate the period until the completion of copying on assumption that the entire file is copied at the calculated speed.

The copy read unit 36 reads a copy of a file generated in a copy destination tier.

Next, a copying control operation of the file read unit 22 is described in the case of copying a file as shown in FIG. 13.

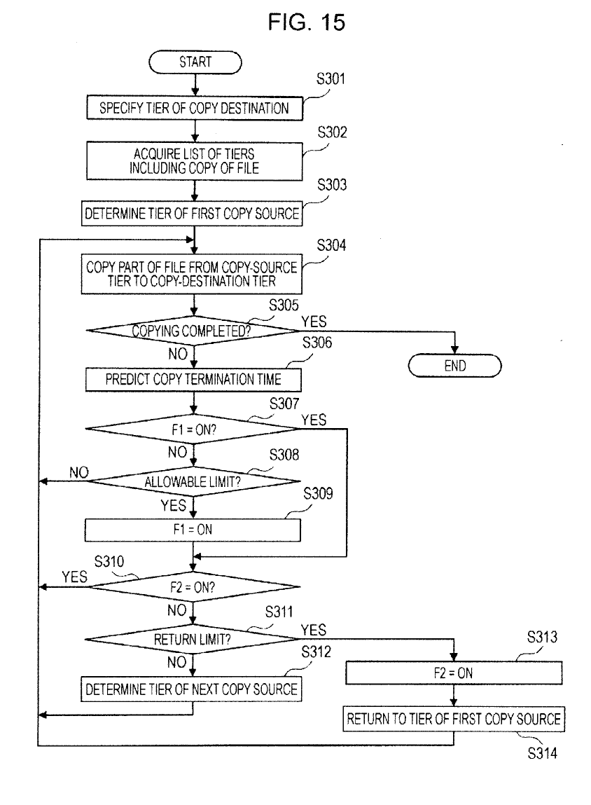

FIG. 15 is a flowchart showing an operational example of the file read unit 22 in this case.

In response to the operation, the copy destination specifying unit 31 obtains information about a copy destination tier (step 301). Here, the copy destination tier is determined as a tier suitable for file access by the path retrieving unit 26 (see FIG. 3), so this information may be obtained from the path retrieving unit 26. In this case, however, unlike the operational examples of FIGS. 4 and 5, the optimum tier is selected from the list of all tiers. In the example of FIG. 13, tier 1 is selected as a copy destination.

Next, the copy source specifying unit 32 obtains a list of copy source tiers (copy source tier list) (step 302). In this case, for example, a list of tiers including a file to be read and operating in a normal mode may be obtained.

Then, the copy source determining unit 33 determines any one of the tiers in the copy source tier list as a first copy source (step 303). In the example of FIG. 13, tier 2 is selected as the first copy source.

As a result, the copying instruction unit 34 instructs the device to copy a part of a file from the copy source tier determined in step 303 to a copy destination tier determined in step 301 (step 304). In the example of FIG. 13, the copy destination tier is tier 1, and the copy source tier is tier 2, so the copying instruction unit 34 instructs the device to copy the file from tier 2 to tier 1. Then, the copying instruction unit 34 determines whether or not the copying is completed (step 305). If the copying is completed, the processing is terminated. If the copying is not completed, the processing advances to step 306.

Then, the time predicting unit 35 estimates a period until the completion of copying and outputs the estimated period to the copy source determining unit 33 (step 306).

In this operational example, as described above with reference to FIG. 13, single copying is performed from tier 2 to tier 1 until the copy completion allowable limit is reached. Thus, a flag F1 representing whether the copy completion allowable limit is reached is set. The flag F1 is set “ON” if the copy completion allowable limit is reached and is set to “OFF” if the copy completion allowable limit is not reached. The copy source determining unit 33 first determines whether the flag F1 is “ON” (step 307). If the flag F1 is “OFF”, that is, the copy completion allowable limit is not reached, it is determined whether the estimated copying completion time exceeds the copy completion allowable limit (step 308). If the estimated copying completion time does not exceed the copy completion allowable limit, the processing returns to step 304 to copy the next part of the file from the same copy source to determine whether or not the copy completion allowable limit is reached. Further, if the copy completion allowable limit is reached in step 308, the copy source determining unit 33 sets the flag F1 “ON” (step 309) to determine whether or not the single copying return limit is reached. On the other hand, if the flag F1 is set “ON” in step 307, the copy completion allowable limit is already reached to determine whether or not the single copying return limit is reached.

Next, the process for determining whether or not the single copying return limit is reached is described. In this operational example, a flag F2 representing whether or not the single copying return limit is reached is set. The flag F2 is set “ON” if the single copying return limit is reached and is set “OFF” if the single copying return limit is not reached. Thus, the copy source determining unit 33 first determines whether or not the flag F2 is set “ON” (step 310). If the flag F2 is set “OFF”, that is, the single copying return limit is not reached, it is determined whether or not an estimated period until the completion of copying is below the signal copying return limit (step 311).

As a result, if the estimated period until the completion of copying is not below the signal copying return limit, any one of the tiers in the copy source tier list except the copy source determined in step 303 is determined as another copy source (step 312). In the example of FIG. 13, tier 3 is selected as another copy source. Then, the processing returns to step 304, and the copying instruction unit 34 instructs the device to copy a part of the file to a copy destination tier from each copy source tier determined in steps 303 and 304 (step 304).

On the other hand, if the estimated period until the completion of copying is below the signal copying return limit, the copy source determining unit 33 sets the flag F2 “ON” (step 313). After that, it is necessary to return to single copying from the copy source determined in step 303, so the other copy source determined in step 312 is omitted from the copy source tiers (step 314). In the example of FIG. 13, tier 3 is not the copy source and only tier 2 remains as the copy source. Then, the processing returns to step 304, and the copying instruction unit 34 instructs the device to copy a part of the file from the copy source tier determined in step 303 to a copy destination tier (step 304).

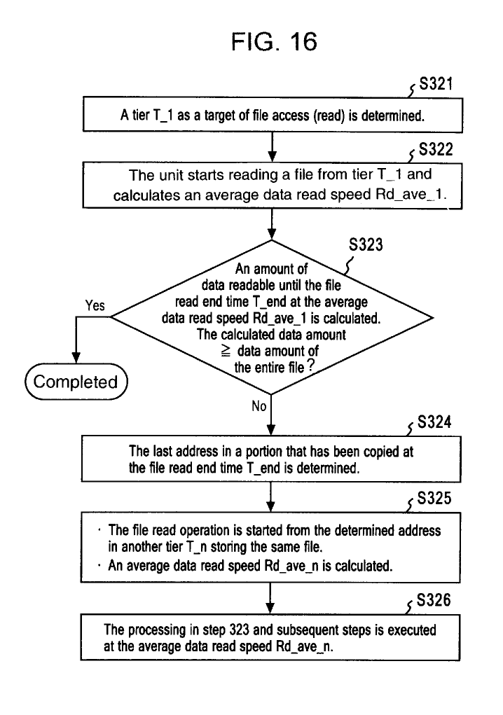

In step 312 of the above operational example, a tier is selected as another copy source, and the address in a file from which copying is started is now described. The address may be determined with various methods. An example thereof is given below and shown in the flowchart in FIG. 16.

A tier T_1 as a target of file access (read) is determined. In this case, tier T_1 is selected as a tier that satisfies the file read end time T_end (step 321).

The file read unit 22 starts reading a file from tier T_1 and in addition, calculates an average data read speed Rd_ave_1 (step 322).

An amount of data readable until the file read end time T_end at the average data read speed Rd_ave_1 is calculated. If the calculated data amount exceeds a data amount of the entire file, the processing is completed (step 323).

If the calculated data amount is smaller than the data amount of the entire file, the last address in a portion that has been copied at the file read end time T_end is determined (step 324).

The file read operation is started from the determined address in another tier T_n storing the same file and in addition, an average data read speed Rd_ave_n is calculated (step 325).

The processing in step 323 and subsequent steps is executed at the average data read speed Rd_ave_n (step 326).

The above description is given of how to generate a file using copies of files in multiple tiers assuming that the multi-tiered storage system includes file access points for each tier. However, the above copying method is applicable to a conventional multi-tiered storage system not including file access points for each tier, for example. In this case, the file access point 11 of FIGS. 10 to 12 may be used not only upon accessing a file on tier 1 but also upon accessing a file on any tier.

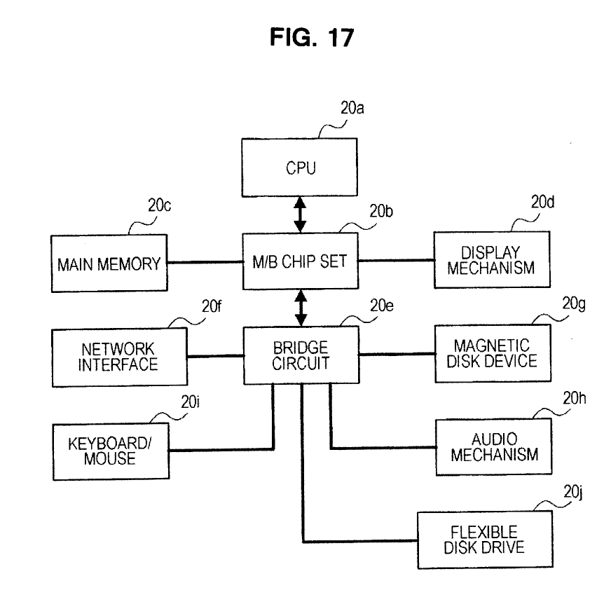

Finally, hardware configuration of a computer to which the embodiment of the present invention is applied is described. That is, the controller 20 is configured using a general-purposed computer. FIG. 17 shows an example of the hardware configuration of the computer. As shown in FIG. 17, the computer includes a CPU (central processing unit) 20a as computing means, a main memory 20c connected to the CPU 20a through an M/B (motherboard) chipset 20b, and a display mechanism 20d connected to the CPU 20a through an M/B chipset 20b. Further, a network interface 20f, a magnetic disk device (HDD) 20g, an audio system 20h, a keyboard/mouse 20i, and a flexible disk drive 20j are connected to the M/B chipset 20b through a bridge circuit 20e.

In FIG. 17, components are connected through a bus. For example, the CPU 20a and the M/B chipset 20b, and the M/B chipset 20b and the main memory 20c are connected through a CPU bus. Further, the M/B chipset 20b and the display mechanism 20d may be connected through an AGP (accelerated graphics point), but if the display mechanism 20d includes a PCI Express-compliant video card, the display mechanism 20d and the video card are connected through a PCI Express (PCIe) bus. Further, in the case of connecting with the bridge circuit 20e, the network interface 20f may be connected using, for example, a PCI Express. Further, the magnetic disk device 20g may be connected using, for example, a serial ATA (AT attachment), a parallel-transfer ATA, or a PCI (peripheral components interconnect). Further, the keyboard/mouse 20i and the flexible disk drive 20j may be connected using a USB (universal serial bus).

Embodiments of the present invention using only hardware components or software components, or both hardware and software components are possible. Further, these include embodiments of the present invention as a computer, as a data processing system, and as a computer program product. The computer program product is stored in a computer-readable medium and provided. The medium can be an electronic, magnetic, optical, electromagnetic, infrared, or semiconductor system, (or apparatus or device) or a propagation medium. Examples of a computer-readable medium include a semiconductor or solid state memory, magnetic tape, a removable computer diskette, a random access memory (RAM), a read-only memory (ROM), a rigid magnetic disk and an optical disk. Current examples of optical disks include compact disk—read only memory (CD-ROM), compact disk—read/write (CD-R/W) and DVD.

While the invention has been described with reference to a preferred embodiment or embodiments, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment disclosed as the best mode contemplated for carrying out this invention, but that the invention will include all embodiments falling within the scope of the appended claims.

1. A device for controlling an access to a storage device having a plurality of storage areas, the device comprising:
a first acquiring unit for acquiring a first information representing a first energy amount necessary to access each of the plurality of storage areas with a required performance;
a second acquiring unit for acquiring a second information representing a second energy amount allowable for the access; and
a selecting unit for selecting a target storage area from the plurality of storage areas in accordance with the first information acquired with the first acquiring unit and the second information acquired with the second acquiring unit.

2. The device according to claim 1, wherein the second acquiring unit acquires the second information in accordance with a priority for energy consumption for the access.

3. The device according to claim 1, wherein the selecting unit selects the target storage area from the plurality of storage areas if the first energy amount necessary to access the target storage area is smaller than the second energy amount allowable for the access.

4. The device according to claim 1, wherein the selecting unit denies the access if the first energy amount necessary to access each of the plurality of storage areas is larger than the second energy amount allowable for the access.

5. The device according to claim 1, wherein the selecting unit waits until the first energy amount becomes smaller than the second energy amount if the first energy amount necessary to access any one of the plurality of storage areas is larger than the second energy amount allowable for the access.

6. The device according to claim 1, wherein if the first energy amount necessary to access any one of the plurality of storage areas is larger than the second energy amount allowable for the access, the selecting unit stops at least one of a plurality of other accesses to set the first energy amount to be smaller than the second energy amount.

7. The device according to claim 1, further comprising:
a generating unit for generating a positional information for identifying at least one selected from the group consisting of a data write position in the target storage area selected by the selecting unit and a data read position in the target storage area.

8. The device according to claim 7, wherein the storage device is a multi-tiered storage system, and wherein the positional information may identify the target storage area selected by the selecting unit.

9. The device according to claim 7, further comprising:
a write unit for writing data to the target storage area using the positional information generated with the generating unit.

10. The device according to claim 7, further comprising:
a read unit for reading data from the target storage area using the positional information generated with the generating unit.

11. The device according to claim 10, wherein the read unit reads a plurality of copies of a target data, each copy of the plurality of copies of the target data being stored in one of the plurality of storage areas, and combines the plurality of copies to read a combined data from the target storage area as the target data.

12. A device for controlling data copying in a storage device having a plurality of storage areas with different performance and energy consumption profiles, the device comprising:
a selecting unit for selecting the plurality of storage areas, each storing one of a plurality of copies of the data; and
a control unit for executing control such that a plurality of different portions of the plurality of copies of the data stored in the plurality of storage areas selected by the selecting unit are copied and combined in a predetermined storage area of the plurality of storage areas.

13. The device according to claim 12, wherein the storage device is a multi-tiered storage system.

14. The storage device according to claim 13, wherein the multi-tiered storage system comprises at least one file access point for each of the plurality of storage areas.

15. A method for controlling an access to a storage device having a plurality of storage areas, comprising:
acquiring a first information representing a first energy amount necessary to access each of the plurality of storage areas with a required performance;
acquiring a second information representing a second energy amount allowable for the access;
selecting a target storage area from the plurality of storage areas in accordance with the first information and the second information;
generating a positional information for identifying at least one selected from the group consisting of a data write position in the target storage area selected by a selecting unit and a data read position in the target storage area; and
performing at least one selected from the group consisting of an operation of writing a target data to the target storage area and an operation of reading the target data from the target storage area using the positional information generated.

16. A program product for causing a computer to function as a device for controlling an access to a storage device having a plurality of storage areas, the computer comprising:
a first acquiring unit for acquiring a first information representing a first energy amount necessary to access each of the plurality of storage areas with a required performance;
a second acquiring unit for acquiring a second information representing a second energy amount allowable for the access; and
a selecting unit for selecting a target storage area from the plurality of storage areas in accordance with the first information acquired with the first acquiring unit and the second information acquired with the second acquiring unit.

17. The device according to claim 1, further comprising:
a list acquiring unit for obtaining a list of storage areas, from the plurality of storage areas, that meet at least one designated file access requirement.

18. The device according to claim 1, further comprising:
an identifier acquiring unit for obtaining a file identifier of a designated file.

19. The device according to claim 11, wherein the read unit begins reading a copy of the target data from a first storage area having at least one of the plurality of copies of the target data, and calculates an average data read speed of the first storage area and an amount of the target data readable at the average data read speed until a read end time.

20. The device according to claim 19, wherein the read unit determines a last address in a portion of the copy of the target data stored in the first storage area at the read end time, if the amount of the target data readable at the average data read speed is smaller than the target data, and begins copying from a starting address in a second storage area having at least one of the plurality of copies of the target data, the starting address being determined by the last address.
